(19) United States
(12) Patent Application Publication
(10) Pub. No.: US 2020/0202813 A1
(43) Pub. Date: Jun. 25, 2020

(54) METHOD FOR ADJUSTING BRIGHTNESS OF DISPLAY SCREEN AND ELECTRONIC DEVICE EMPLOYING THE METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: CHENG-XIANG LIU, Shenzhen (CN)

(21) Appl. No.: 16/455,915

(22) Filed: Jun. 28, 2019

(30) Foreign Application Priority Data
Dec. 19, 2018 (CN) 201811560008.8

(51) Int. Cl. G09G 5/10

(52) U.S. Cl. CPC G09G 5/10; G09G 2320/0626; G09G 2360/144

(57) ABSTRACT

A method for adjusting brightness of a display screen of a handheld electronic device in different orientations to suit the holder of the device and other viewers includes detecting a tilt angle of the electronic device by an angle sensor when the display screen is turned on, and determining the degree of tilt according to predetermined angle ranges. The method further includes detecting brightness of light at sensed orientations by turning on at least one of several light sensors and adjusting brightness of the display screen accordingly, for optimal viewing.

### FIELD

The subject matter herein generally relates to display technology.

### BACKGROUND

Electronic devices, such as mobile phones, are equipped with a display device. The electronic device can automatically adjust brightness of the display device but only according to general brightness of surrounding environment.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2A is a schematic diagram of position of a light sensor on the front of the electronic device of FIG. 1.

FIG. 2B is a schematic diagram of position of a light sensor on the side of the electronic device of FIG. 1.

FIG. 2C is a schematic diagram of position of a light sensor on the back of the electronic device of FIG. 1.

FIG. 3 is a schematic diagram illustrating a tilt angle determination of the electronic device of FIG. 1.

FIG. 4 illustrates a flowchart of one embodiment of a brightness adjusting method using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprises” means “including, but not necessarily limited to”; it specifically indicates open-ended inclusion or membership in a so-described combination, group, series, and the like.

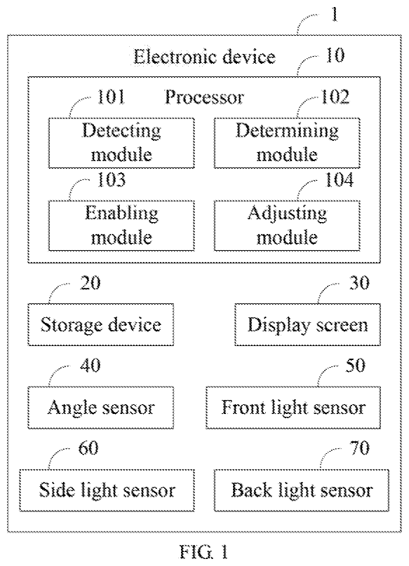

FIG. 1 shows one embodiment of an electronic device (electronic device 1). Depending on the embodiment, the electronic device 1 can include, but is not limited to, at least one processor 10, a storage device 20, a display screen 30, an angle sensor 40, and several light sensors. The storage device 20, at least one processor 10, and the display screen 30 communicate with each other through a system bus.

In at least one exemplary embodiment, the storage device 20 can be an internal storage device, such as a flash memory, a random access memory (RAM) for temporary storage of parameters, and/or a read-only memory (ROM) for permanent storage of parameters. The storage device 20 can also be an external storage device, such as an external hard disk, a storage card, or a data storage medium. The at least one processor 10 can be a central processing unit (CPU), a microprocessor, or other data processor chip that performs functions of the electronic device 1.

In at least one exemplary embodiment, the display screen 30 can be a liquid crystal display (LCD) touch screen, or an organic light emitting diode display (OLED) touch screen. The angle sensor 40 can be a gyroscope.

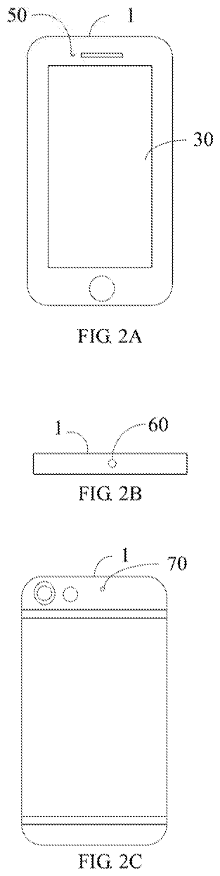

In at least one exemplary embodiment, the light sensors can include a front light sensor 50, a side light sensor 60, and a back light sensor 70. The light sensors can sense ambient brightness in their locality. As shown in FIG. 2A, the front light sensor 50 is located on a front side of the electronic device 1, and above the display screen 30. As shown in FIG. 2B, the side light sensor 60 is located on a side of the electronic device 1. In this embodiment, the side of the electronic device 1 is the side above the front light sensor 50 in FIG. 2A. The back light sensor 70 is located on the back of the electronic device 1 and close to a camera of the electronic device 1.

In at least one exemplary embodiment, the electronic device 1 can be, but is not limited to, a smart phone, a tablet computer, a smart watch, or any other suitable electronic device. FIG. 1 illustrates only one example of the electronic device 1, other examples can comprise more or fewer components that those shown in the embodiment, or have a different configuration of the various components. For example, the electronic device 1 can further include a circuit system, input/output interface, a battery, an operating system, and so on.

In at least one exemplary embodiment, the processor 10 as shown in FIG. 1 can include, but is not limited to, a detecting module 101, a determining module 102, an enabling module 103, and an adjusting module 104. The modules 101-104 can comprise computerized instructions in the form of one or more computer-readable programs that can be stored in a non-transitory computer-readable medium, for example in the storage device 20, and executed by the processor 10 of the electronic device 1.

In at least one exemplary embodiment, the detecting module 101 can detect whether the display screen 30 is turned on or off. The detecting module 101 can determine whether the display screen 30 is turned on by detecting an operation which turns on the display screen 30. Such operation can include at least a message being received, a trigger action of a lock button, a finger-print verification, and insertion of a headset. The message being received can include at least a call, a text message, and a push notification of applications.

In at least one exemplary embodiment, the detecting module 101 further can detect a tilt angle of the electronic device 1 by the angle sensor 40 when the display screen 30 is turned on. The tilt angle is an angle between the back surface of the electronic device 1 and a horizontal plane.

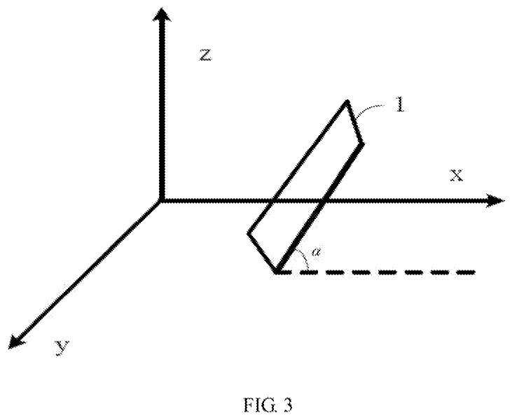

In at least one exemplary embodiment, the angle sensor 40 can detect a posture of the electronic device 1 in a three-dimensional space. Referring to FIG. 3, and taking a three-dimensional coordinate system as an example, the x-axis and the y-axis of the three-dimensional coordinate system are in a horizontal plane, and the z-axis is perpendicular to the horizontal plane. An angle a between the back surface of the electronic device 1 and the x-axis is the tilt angle of the electronic device 1.

In at least one exemplary embodiment, the determining module 102 can determine whether the tilt angle of the electronic device 1 falls within at least one predetermined angle range. The at least one predetermined angle range can include a first predetermined angle range, a second predetermined angle range, a third predetermined angle range, and a fourth predetermined angle range. The first predetermined angle range is between 0° and 60°, the second predetermined angle range is between 180° and 360°, the third predetermined angle range is between 30° and 90°, and the fourth predetermined angle range is between 60° and 180°.

In at least one exemplary embodiment, the enabling module 103 can turn on at least one light sensor when a tilt angle is within a predetermined angle range. The adjusting module 104 can adjust brightness of the display screen 30 according to the detected brightness of the environment.

In at least one exemplary embodiment, the enabling module 103 can turn on the front light sensor 50 to detect the brightness of the environment when the tilt angle is within the first or second predetermined angle ranges. The enabling module 103 can turn on the side light sensor 60 to detect the brightness of the environment when the tilt angle is within the third predetermined angle range. The enabling module 103 can turn on the back light sensor 70 to detect the brightness of the environment when the tilt angle is within the fourth predetermined angle range.

In at least one exemplary embodiment, when the tilt angle is within the first predetermined angle range but out of the third predetermined angle range (that is, the tilt angle α is between 0° and 30°), the enabling module 103 just turns on the front light sensor 50 to detect the brightness in front of the display screen 30. When the tilt angle is within the first and the third predetermined angle ranges (that is, the tilt angle a is between 30° and 60°), the enabling module 103 can turn on the front light sensor 50 and the side light sensor 60 at the same time to detect the brightness in front of the display screen 30 and beside the display screen 30.

In at least one exemplary embodiment, when the tilt angle is within the third and the fourth predetermined angle ranges (that is, the tilt angle α is between 60° and 90°), the enabling module 103 can turn on the side light sensor 60 and the back light sensor 70 at the same time to detect the brightness at the side and back of the display screen 30. When the tilt angle is within the fourth but out of the third predetermined angle ranges (that is, the tilt angle α is between 90° and 180°), the user may look up the display screen 30, then the enabling module 103 can turn on the back light sensor 70 to detect the brightness at the back of the display screen 30. When the tilt angle is within the second predetermined angle range, that is the tilt angle α is between 180° and 360°. The user may be behind the display screen 30 and show the display screen 30 to other users, then the enabling module 103 can turn on the front light sensor 50 to detect the brightness in front of the display screen 30.

In at least one exemplary embodiment, the determining module 102 further can determine the maximum brightness of a plurality of light brightnesses, as detected by a number of the light sensors, and set such maximum brightness as the current light brightness, when the number of the light sensors of the electronic device 1 are turned on.

In at least one exemplary embodiment, when the tilt angle is within the first and third predetermined angle ranges, or the tilt angle is within the third and fourth predetermined angle ranges, the enabling module 103 can turn on two light sensors. The determining module 102 can determine that the greater of two light brightness values detected by the two light sensors is the current light brightness. The adjusting module 104 can adjust brightness of the display screen 30 according to the determined light brightness. The technique of adjusting the brightness of the display screen 30 according to the determined light brightness is prior art and will not be described in detail herein.

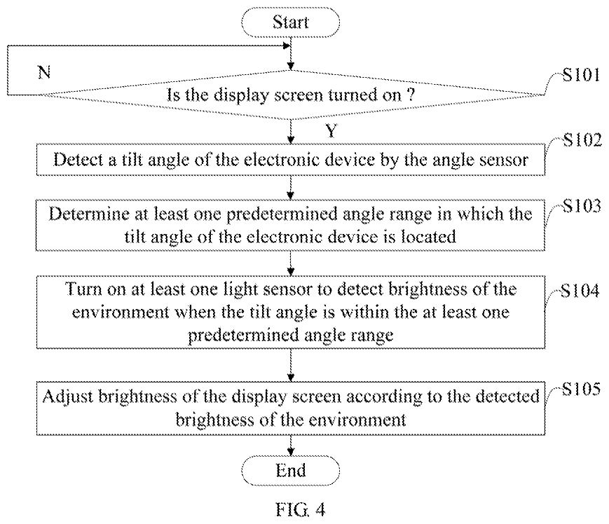

FIG. 4 illustrates a flowchart of a method for adjusting the brightness of the display screen of the electronic device. In an example embodiment, the method is performed by execution of computer-readable software program codes or instructions by the processor 10 of the electronic device 1.

Referring to FIG. 4, the method is provided by way of example, as there are a variety of ways to carry out the method. The method described below can be carried out using the configurations illustrated in FIG. 1, for example, and various elements of these figures are referenced in explaining method. Each block shown in FIG. 4 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S101.

At block S101, the detecting module 101 can detect whether the display screen 30 is turned on or off. When the display screen 30 is turned on, the process goes to block S102. When the display screen 30 is turned off, the process returns to block S101.

At block S102, the detecting module 101 can detect a tilt angle of the electronic device 1 by the angle sensor 40 when the display screen 30 is turned on.

At block S103, the determining module 102 can determine at least one predetermined angle range in which the tilt angle of the electronic device 1 is located.

At block S104, the enabling module 103 can turn on at least one light sensor to detect brightness of the environment when the tilt angle is within the at least one predetermined angle range.

In at least one exemplary embodiment, the block S104 further includes: when the tilt angle is within the first predetermined angle range but out of the third predetermined angel range, the enabling module 103 just turns on the front light sensor 50 to detect the brightness in front of the display screen 30. When the tilt angle is within the first and the third predetermined angle ranges, the enabling module 103 can turn on the front light sensor 50 and the side light sensor 60 at the same time to detect the brightness in front of the display screen 30 and beside the display screen 30. When the tilt angle is within the third and the fourth predetermined angle ranges, the enabling module 103 can turn on the side light sensor 60 and the back light sensor 70 at the same time to detect the brightness on the side and back of the display screen 30. When the tilt angle is within the fourth predetermined angle range but out of the third predetermined angel range, the enabling module 103 can turn on the back light sensor 70 to detect the brightness on back of the display screen 30. When the tilt angle is within the second predetermined angle range, the enabling module 103 can turn on the front light sensor 50 to detect the brightness in front of the display screen 30.

At block S105, the adjusting module 104 can adjust brightness of the display screen 30 according to the detected brightness of the environment.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a display screen;
an angle sensor;
a plurality of light sensors;
a storage device; and
at least one processor, wherein
the storage device storing one or more programs that, when executed by the at least one processor, cause the at least one processor to:
detect a tilt angle of the electronic device by the angle sensor when the display screen is turned on;
determine at least one predetermined angle range in which the tilt angle of the electronic device is located;
detect brightness of environment by turning on at least one light sensor of the plurality of light sensors when the tilt angle is within the at least one predetermined angle range; and
adjust brightness of the display screen according to the detected brightness of the environment.

2. The electronic device according to claim 1, wherein the tilt angle is an angle between the back surface of the electronic device and a horizontal plane, and the angle sensor is a gyroscope.

3. The electronic device according to claim 1, wherein the at least one predetermined angle range comprises a first predetermined angle range, a second predetermined angle range, a third predetermined angle range, and a fourth predetermined angle range, the first predetermined angle range is between 0° and 60°, the second predetermined angle range is between 180° and 360°, the third predetermined angle range is between 30° and 90°, and the fourth predetermined angle range is between 60° and 180°.

4. The electronic device according to claim 3, wherein the plurality of light sensors comprise a front light sensor which is located on a front side of the electronic device, a side light sensor which is located on a side of the electronic device, and a back light sensor which is located on the back of the electronic device.

5. The electronic device according to claim 4, wherein the at least one processor is further caused to:
detect the brightness of the environment by turning on the front light sensor when the tilt angle is within the first predetermined angle range or the second predetermined angle range;
detect the brightness of the environment by turning on the side light sensor when the tilt angle is within the third predetermined angle range; and
detect the brightness of the environment by turning on the back light sensor when the tilt angle is within the fourth predetermined angle range.

6. The electronic device according to claim 4, wherein the at least one processor is further caused to:
turn on the front light sensor when the tilt angle is within the first predetermined angle range but out of the third predetermined angel range;
turn on the front light sensor and the side light sensor at the same time when the tilt angle is within the first and the third predetermined angle ranges;
turn on the side light sensor and the back light sensor at the same time when the tilt angle is within the third and the fourth predetermined angle ranges;
turn on the back light sensor when the tilt angle is within the fourth predetermined angle range but out of the third predetermined angel range; and
turn on the front light sensor when the tilt angle is within the second predetermined angle range.

7. The electronic device according to claim 1, wherein the detected brightness is a maximum light brightness detected by the plurality of light sensors.

8. A brightness adjusting method applicable in an electronic device, the electronic device comprising a display screen, an angle sensor, and a plurality of light sensors, the method comprising:
detecting a tilt angle of the electronic device by the angle sensor when the display screen is turned on;
determining at least one predetermined angle range in which the tilt angle of the electronic device is located;
detecting brightness of environment by turning on at least one light sensor of the plurality of light sensors when the tilt angle is within the at least one predetermined angle range; and
adjusting brightness of the display screen according to the detected brightness of the environment.

9. The method according to claim 8, wherein the tilt angle is an angle between the back surface of the electronic device and a horizontal plane, and the angle sensor is a gyroscope.

10. The method according to claim 8, wherein the at least one predetermined angle range comprises a first predetermined angle range, a second predetermined angle range, a third predetermined angle range, and a fourth predetermined angle range, the first predetermined angle range is between 0° and 60°, the second predetermined angle range is between 180° and 360°, the third predetermined angle range is between 30° and 90°, and the fourth predetermined angle range is between 60° and 180°.

11. The method according to claim 10, wherein the plurality of light sensors comprise a front light sensor which is located on a front side of the electronic device, a side light sensor which is located on a side of the electronic device, and a back light sensor which is located on the back of the electronic device.

12. The method according to claim 11, wherein the method further comprises:
detecting the brightness of the environment by turning on the front light sensor when the tilt angle is within the first predetermined angle range or the second predetermined angle range;
detecting the brightness of the environment by turning on the side light sensor when the tilt angle is within the third predetermined angle range; and
detecting the brightness of the environment by turning on the back light sensor when the tilt angle is within the fourth predetermined angle range.

13. The method according to claim 11, wherein the method further comprises:
turning on the front light sensor when the tilt angle is within the first predetermined angle range but out of the third predetermined angel range;
turning on the front light sensor and the side light sensor at the same time when the tilt angle is within the first and the third predetermined angle ranges;
turning on the side light sensor and the back light sensor at the same time when the tilt angle is within the third and the fourth predetermined angle ranges;
turning on the back light sensor when the tilt angle is within the fourth predetermined angle range but out of the third predetermined angel range; and
turning on the front light sensor when the tilt angle is within the second predetermined angle range.

14. The method according to claim 8, wherein the detected brightness is a maximum light brightness detected by the plurality of light sensors.

15. A non-transitory storage medium having stored thereon instructions that, when executed by a processor of an electronic device, causes the processor to perform a brightness adjusting method, the electronic device comprising a display screen, an angle sensor, and a plurality of light sensors, the method comprising:
detecting a tilt angle of the electronic device by the angle sensor when the display screen is turned on;
determining at least one predetermined angle range in which the tilt angle of the electronic device is located;
detecting brightness of environment by turning on at least one light sensor of the plurality of light sensors when the tilt angle is within the at least one predetermined angle range; and
adjusting brightness of the display screen according to the detected brightness of the environment.

16. The non-transitory storage medium according to claim 15, wherein the tilt angle is an angle between the back surface of the electronic device and a horizontal plane, and the angle sensor is a gyroscope.

17. The non-transitory storage medium according to claim 15, wherein the at least one predetermined angle range comprises a first predetermined angle range, a second predetermined angle range, a third predetermined angle range, and a fourth predetermined angle range, the first predetermined angle range is between 0° and 60°, the second predetermined angle range is between 180° and 360°, the third predetermined angle range is between 30° and 90°, and the fourth predetermined angle range is between 60° and 180°.

18. The non-transitory storage medium according to claim 17, wherein the plurality of light sensors comprise a front light sensor which is located on a front side of the electronic device, a side light sensor which is located on a side of the electronic device, and a back light sensor which is located on the back of the electronic device.

19. The non-transitory storage medium according to claim 18, wherein the method further comprises:
detecting the brightness of the environment by turning on the front light sensor when the tilt angle is within the first predetermined angle range or the second predetermined angle range;
detecting the brightness of the environment by turning on the side light sensor when the tilt angle is within the third predetermined angle range; and
detecting the brightness of the environment by turning on the back light sensor when the tilt angle is within the fourth predetermined angle range.

20. The non-transitory storage medium according to claim 18, wherein the method further comprises:
turning on the front light sensor when the tilt angle is within the first predetermined angle range but out of the third predetermined angel range;
turning on the front light sensor and the side light sensor at the same time when the tilt angle is within the first and the third predetermined angle ranges;
turning on the side light sensor and the back light sensor at the same time when the tilt angle is within the third and the fourth predetermined angle ranges;
turning on the back light sensor when the tilt angle is within the fourth predetermined angle range but out of the third predetermined angel range; and
turning on the front light sensor when the tilt angle is within the second predetermined angle range.
